(19) United States
(12) Patent Application Publication
(10) Pub. No.: US 2017/0297365 A1
(43) Pub. Date: Oct. 19, 2017

(54) DECORATIVE FABRIC

(71) Applicant: William Franklin, Long Beach, CA (US)

(72) Inventor: William Franklin, Long Beach, CA (US)

(21) Appl. No.: 15/098,054

(22) Filed: Apr. 13, 2016

(51) Int. Cl. B44F 5/00; B44F 1/00

(52) U.S. Cl. CPC B44F 5/00; B44F 1/00

(57) ABSTRACT

A decorative fabric is disclosed having a plurality of tiles attached to a fabric. The tiles are spaced in relation to each other such as to allow the fabric to be flexible by being bent in any given direction. In one preferred embodiment the plurality of tiles are each a one inch by one inch square and are spaced one eighth of an inch apart from each other when attached to the fabric thereby allowing the fabric to bend and be flexible.

### FIELD OF THE INVENTION

The present invention relates to decorative tiles applied to worn clothing and fabrics in patterns used to add an additional decorative effect to a soft material that allows a viewer to get a different visual experience.

### BACKGROUND OF THE INVENTION

There are many decorative cloth design that through the use of embroidery and the like emphasize a unique style to meet the needs of consumers tastes. In order to effectively highlight the visual pattern, color, material and pattern selection processing methods themselves are an important factor affecting the pattern of effects presented. Typically, the pattern presented in clothes is a static design, wherein when the pattern style and color are viewed from different angles give a stiff visual experience. Therefore, there is a need for a decorative cloth design that is dynamic, three dimensional or appears visually fluid in use.

### SUMMARY

A decorative fabric is disclosed having a plurality of tiles attached to a fabric. The tiles are spaced in relation to each other such as to allow the fabric to be flexible by being bent in any given direction. In one preferred embodiment the plurality of tiles are each a one inch by one inch square and are spaced one eighth of an inch apart from each other when attached to the fabric thereby allowing the fabric to bend and be flexible.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

In the accompanying drawings:

FIG. 1 is a top plan view of the flexible fabric having decorative tiles in accordance with the present invention; and

FIG. 2 is a back perspective view of the decorative tiles attached to the back of a backpack in a pattern configuration according to the present invention.

### DETAILED DESCRIPTION OF THE INVENTION

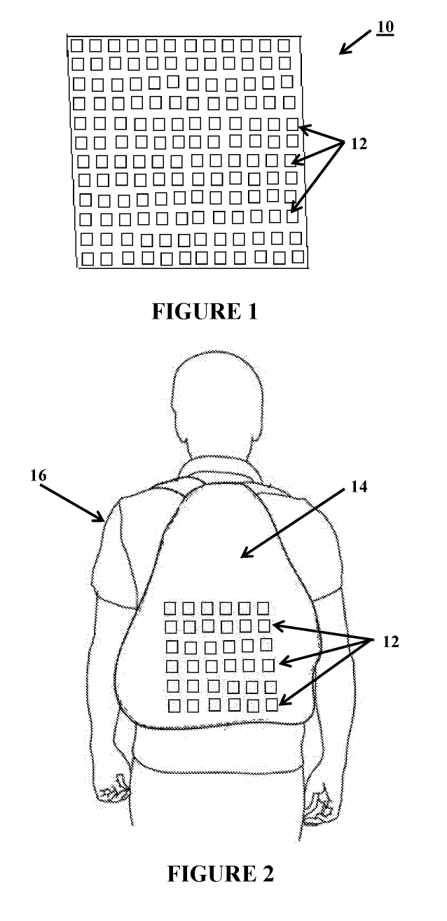

Referring now to FIG. 1 there is shown a decorative fabric 10 having a plurality of tiles 12 attached to the fabric 10. The tiles 12 are spaced in relation to each other such as to allow the fabric 10 to be flexible by being bent in any given direction. In one preferred embodiment, the plurality of tiles 12 are each a one inch to two inch by one inch to two inch square and are spaced one eighth of an inch to one inch apart from each other when attached to the fabric 10 thereby allowing the fabric 10 to bend and be flexible. The plurality of tiles 12 may be attached to the fabric 10 by use of an adhesive such as glue and the like. In another preferred embodiment, the tiles 12 are each round in shape having a one inch diameter and are spaced one eighth of an inch to one inch apart from each other. In yet another preferred embodiment, the tiles 12 are each triangular or rectangular in shape and are spaced one eighth of an inch apart from each other. Also, it should be understood that the tiles 12 may be chosen from one or more of the following materials:

1) mirrored plexiglass;
2) textured plexiglass;
3) translucent plexglass;
4) transparent plexiglass;
5) fluorescent plexiglass;
6) frosted plexiglass;
7) acrylic glitter and pearl;
8) non glare plexiglass;
9) plastic illusion film;
10) plastic illusion film 3D; and
11) etched plexglass

Referring now to FIG. 2, there is shown the ties 12 of the present invention attached to the back of a backpack 14 being worn by a user 16. Additionally, the tiles 12 may arranged is different patterns to illustrate a variety of design features such as displaying a mosaic that appears as a picture and the like.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. A decorative fabric, comprising:
a plurality of tiles attached to fabric wherein said tiles are spaced in relation to each other such as to allow said fabric to be flexible by being bent in any given direction.

2. The decorative fabric according to claim 1, wherein said plurality of tiles are each a one inch to two inch by one inch to two inch square and are spaced one eighth of an inch to one inch apart from each other.

3. The decorative fabric according to claim 1, wherein said plurality of tiles are each round having a one inch diameter and are spaced one eighth of an inch to one inch apart from each other.

4. The decorative fabric according to claim 1, wherein said plurality of tiles are each triangular in shape and are spaced one eighth of an inch to one inch apart from each other.

5. The decorative fabric according to claim 1, wherein said plurality of tiles are mirrored plexiglass.

6. The decorative fabric according to claim 1, wherein said plurality of tiles are textured plexiglass.

7. The decorative fabric according to claim 1, wherein said plurality of tiles are translucent plexglass.

8. The decorative fabric according to claim 1, wherein said plurality of tiles are transparent plexiglass.

9. The decorative fabric according to claim 1, wherein said plurality of tiles are fluorescent plexiglass.

10. The decorative fabric according to claim 1, wherein said plurality of tiles are frosted plexiglass.

11. The decorative fabric according to claim 1, wherein said plurality of tiles are acrylic glitter and pearl.

12. The decorative fabric according to claim 1, wherein said plurality of tiles are non glare plexiglass.

13. The decorative fabric according to claim 1, wherein said plurality of tiles are plastic illusion film.

14. The decorative fabric according to claim 1, wherein said plurality of tiles are each a one inch by one inch square and are spaced one eighth of an inch apart from each other.

15. The decorative fabric according to claim 1, wherein said plurality of tiles are plastic illusion film 3D.

16. The decorative fabric according to claim 1, wherein said plurality of tiles are etched plexglass.

17. The decorative fabric according to claim 1, wherein said plurality of tiles are attached in a pattern to a back of a backpack.

18. The decorative fabric according to claim 1, wherein said plurality of tiles are attached to said fabric by an adhesive.

19. The decorative fabric according to claim 1, wherein said plurality of tiles are each rectangular in shape and are spaced one eighth of an inch to one inch apart from each other.
